(19) United States
(12) Patent Application Publication
(10) Pub. No.: US 2003/0107201 A1
(43) Pub. Date: Jun. 12, 2003

(54) Multi-link suspension for a vehicle

(76) Inventor: Dong-Kee Chun, Suwon-City (KR)

Correspondence Address: Pennie & Edmonds, LLP, 3300 Hillview Avenue, Palo Alto, CA, 94304, US

(21) Appl. No.: 10/310,369

(22) Filed: Dec. 4, 2002

(30) Foreign Application Priority Data
Dec. 6, 2001 (KR) 2001-0076826

(51) Int. Cl. B62D 7/20; B60G 3/18

(52) U.S. Cl. 280/124.135; 280/93.511

(57) ABSTRACT

Volumetric efficiency and steering accuracy are increased and manufacturing tolerance is reduced in a multi-link suspension of a vehicle having a wheel carrier for rotatably supporting a wheel and a plurality of control arms for connecting a vehicle body and one of upper and lower portions of the wheel carrier, by connecting the wheel carrier and the plurality of control arms by a unified ball joint unit interposed therebetween.

### FIELD OF THE INVENTION

Generally, the present invention relates to suspension for a vehicle. More particularly, the present invention relates to suspension control arms linked to a wheel carrier by a modularized ball joint.

### BACKGROUND OF THE INVENTION

Vehicle suspension is disposed between the body of the vehicle and the wheel, and interconnects the body and wheel by one or more links. The suspension vertically supports the wheel through a spring and shock absorber assembly, providing harmony of strength and softness, while enabling motion of the wheel relative to the vehicle body.

Some typical suspension components include; upper and lower control arms, a wheel carrier, and a ball-joint. The upper and lower control arms interconnect the vehicle body and the wheel carrier. The wheel carrier rotatably supports the wheel and the ball joint rotatably links the wheel carrier to the control arms.

Often, in a multi-link suspension, a pair of lower control arms connects the lower portion of the wheel carrier to the vehicle body and a pair of upper control arms connects the upper portion of the wheel carrier to the vehicle body. Typically each control arm is connected to the wheel carrier through a corresponding ball joint. Thus, if there are two upper control arms, there are two corresponding upper ball joints, etc.

Ball joints typically consist of a housing or casing, and a ball with a ball stud. The balls of the ball joint are inserted into cases that are integrally formed to the control arms, such that the balls can spherically rotate in their respective cases. In use, a wheel carrier is connected to the ball studs of the ball joint balls.

Steering of the wheel of a vehicle is enabled due to the spherical rotation of the balls of the ball joints within their respective cases. During steering, the cases of the ball joints rotate and change position in accordance with movement of the control arms. Therefore there must be clearance between the ends of the control arms such that the cases that encase the ball joints do not contact each other. A minimal gap “g” and/or height difference “h” must be provided between the two cases to prevent interference there between upon steering. In the current connecting structure using separate ball joints at the end of each control arm, there is a limitation as to how much the distance between the ball joint cases can be reduced to because the ball joint cases must pass by each other during steering.

Another factor that decreases the accuracy of steering, decreases volumetric efficiency of the suspension, and increases torque is the position of the instantaneous rotating center of the wheel. The instantaneous rotating center is the point at which the wheel is steered about. It is the point where connecting lines, extrapolated from a line along the control arms crosses. When the wheel is linearly aligned, as on a straight road, the instantaneous rotating center is in one position. When the wheel is steered, the position of the instantaneous rotating center changes because the connecting lines of the control arms change. The position change of the instantaneous rotating center of the current designs is relatively large. This decreases accuracy, decreases volumetric efficiency of the suspension, and increases torque. Therefore, the position change of the instantaneous rotating center should preferably be as small as possible in order to provide better steering performance and feel.

Furthermore, the height difference between the center of the balls of the ball joints, which is generally increased in order to reduce the horizontal distance between the two ball joints, often causes an increase of steering torque, a loss in steering accuracy, and a loss in volumetric efficiency of the associated suspension.

Moreover, using separate ball joints for each control arm increases the number of parts requiring assembly, consequently increasing production cost and assembly time.

What is needed is a device that minimizes the height and distance between the ball joint centers while reducing the number of associated parts.

### SUMMARY OF THE INVENTION

The present invention provides a multi-link suspension for a vehicle that reduces the number of parts used, reduces the manufacturing cost, lowers assembly time, reduces steering torque, increases volumetric efficiency, and increases steering accuracy.

An exemplary multi-link suspension of a vehicle that is useful with the present invention includes: a wheel carrier for rotatably supporting a wheel; a plurality of control arms for connecting a vehicle body to the upper and lower portions of the wheel carrier; and a unified ball joint unit interposed between, and connecting, the wheel carrier to the plurality of control arms.

Also, in an embodiment of the present invention, by placing the balls of the ball joints closer to each other reduces the movement of the instantaneous rotating center of the wheel during steering. Therefore, reducing the friction caused during steering and increasing the accuracy and the volumetric efficiency of the suspension. Furthermore, the tolerance of one unified ball joint unit is less than the sum of the tolerance of each of two ball joints, which consequently increases performance of a vehicle suspension, and accordingly, a vehicle.

Furthermore, in an embodiment of the present invention, a ball joint unit suspension component for a vehicle comprising is disclosed. The ball joint unit includes at least two ball joints, wherein each of the ball joints are configured with a ball portion and a ball stud portion. Also disclosed is a case that is configured to rotatably enclose at least two of the ball joints wherein the ball stud portions of the ball joints project 180 degrees in opposite directions, through the case.

### BRIEF DESCRIPTION OF THE DRAWINGS

The accompanying drawings, which are incorporated in and constitute a part of the specification, illustrate an embodiment of the invention, and, together with the description, serve to explain the principles of the invention. Objects and aspects of the invention will become apparent from the following description of preferred embodiments with reference to the accompanying drawings in which:

FIG. 1 is a perspective view of a multi-link front suspension according to a preferred embodiment of the present invention;

FIG. 2 illustrates a type of linkage of a ball-joint unit and a wheel carrier according to a preferred embodiment of the present invention; and

FIG. 3 is a sectional view of a ball-joint unit according to a preferred embodiment of the present invention.

### DETAILED DESCRIPTION OF THE PREFERRED EMBODIMENTS

A preferred embodiment of the present invention will hereinafter be described in detail with reference to the accompanying drawings.

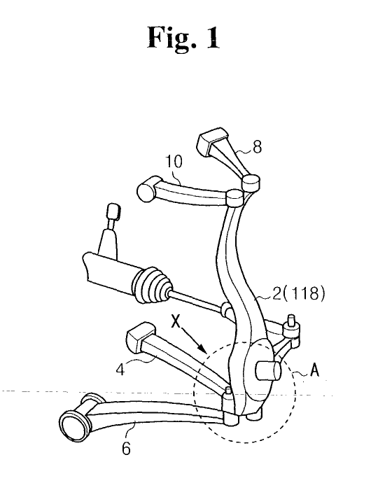

According to a preferred embodiment of the present invention, as shown in FIG. 1, a wheel carrier 2 for rotatably supporting a wheel is connected to a vehicle body (not shown) at its lower portion by lower control arms 4 and 6, and at its upper portion by the upper control arms 8 and 10. A unified ball joint unit 20 connects the lower control arms 4 and 6, to the lower portion of the wheel carrier 2. The upper control arms 8 and 10 are also connected to the wheel carrier 2 by a unified ball joint unit 20.

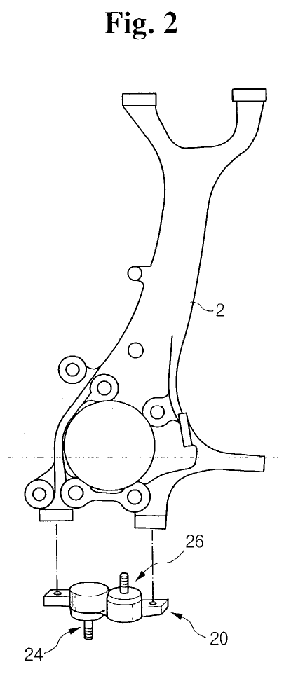

In FIG. 2, only the unified ball joint unit 20 for connecting the lower control arms to the wheel carrier 2 is shown, but a similar unified ball joint unit 20 is also used at an upper portion of the wheel carrier 2 to connect the upper control arms 8 and 10 to the wheel carrier 2.

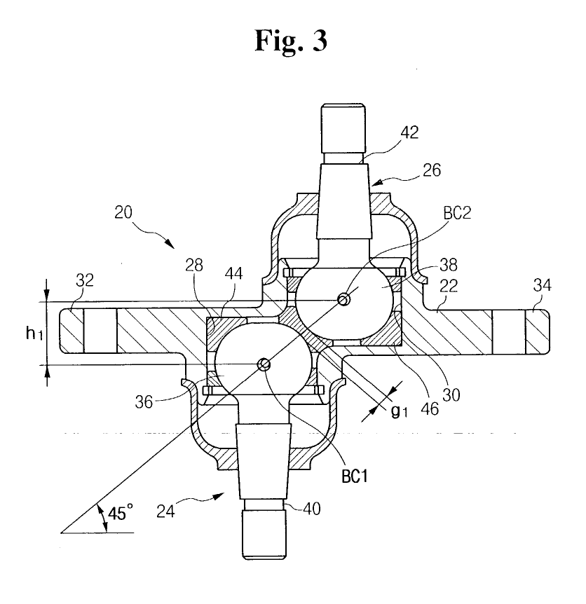

As shown in FIG. 3, the unified ball joint unit 20 has one case 22 whereto two ball studs 24 and 26 are assembled.

A downward ball stud 24 and an upward ball stud 26 are assembled respectively through spaces 28 and 30 formed in the case 22. The downward ball stud 24 and the upward ball stud 26 project from the case 22 180 degrees from each other. Fastening projections 32 and 34 are formed at either side of the case 22 such that the case 22 can be adjoined to the wheel carrier 2.

The downward ball stud 24, having its ball 36 inside the space 28, has its projection 40 projected downward from the case 2, and the upward ball stud 26, having its ball 38 inside the space 30, has its projection 42 projected upward from the case 2.

Members 44 and 46, for lubricating and supporting the balls 36 and 38 are respectively disposed in the spaces 28 and 30 such that the members 44 and 46 respectively spherically contact the balls 36 and 38. An imaginary line connecting centers BC1 and BC2 of the balls 36 and 38 is at about 45 degrees with respect to a horizontal plane.

The angle between the horizontal plane and the imaginary line connecting the ball centers BC1 and BC2 (FIG. 3) may be slightly varied according to a specific vehicle specification, keeping in mind that such a degree is proposed as a least angle that minimizes the distances “g1” and “h1” that can prevent interference while the ball studs 24 and 26 spherically rotate during steering.

The ball studs 24 and 26 may not be aligned exactly along the lengthwise direction (horizontal direction of FIG. 3) of the case 22. According to a preferred embodiment of this invention, the distance between the ball studs 24 and 26 is minimized.

In use, the closer the ball 36 and 38 can be placed to each other, the closer the instantaneous rotating center of the wheel is to the ends of the control arms that are connected to the wheel, thereby reducing friction caused while steering the wheel, and increasing the responsive accuracy of the wheel to steering operations.

Furthermore, the tolerance of one unified ball joint unit 20 is less than the sum of the tolerance of each of two ball joints, which consequently increases reliability of performance of a suspension, and accordingly, a vehicle.

Furthermore, a unified ball joint unit 20 enables reduction of manufacturing cost and assembling time of a multi-link suspension, while increasing the ease of installation of the ball joint unit 20 to the wheel carrier 2.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims

What is claimed is:

1. A multi-link suspension of a vehicle comprising:
a wheel carrier for rotatably supporting a wheel;
a plurality of control arms for connecting a vehicle body and a portion of the wheel carrier; and
a unified ball joint unit including more than one ball interposed between and connecting the wheel carrier and the plurality of control arms.

2. The multi-link suspension of claim 1, wherein the plurality of control arms comprises a first and a second control arm, and the unified ball joint unit comprises:
a first ball stud extending from one said ball connected to the first control arm; and
a second ball stud extending from another said ball connected to the second control arm, wherein said first and second ball studs are projecting in opposite directions.

3. The multi-link suspension of claim 2, wherein a line connecting centers of the balls of the first and second ball studs is at about 45 degrees with respect to a horizontal plane.

4. A multi-link suspension of a vehicle comprising:
a wheel carrier for rotatably supporting a wheel;
a plurality of control arms for connecting a vehicle body and a portion of a wheel carrier; and
a ball joint unit configured with a case configured to rotatably enclose a ball portion of a first and a second ball joint, wherein a ball stud of said first ball joint protrudes perpendicular from said case, and a ball stud of said second ball joint protrudes from said case, directed 180 degrees from said ball stud portion of said first ball joint.

5. The multi-link suspension of claim 4, wherein a line connecting centers of balls of the first and second ball studs is at about 45 degrees with respect to a horizontal plane.

6. The multi-link suspension of claim 4, wherein said ball stud is configured to couple with a control arm.

7. The multi-link suspension of claim 4, wherein said case is configured to couple with a wheel carrier.

8. A ball joint unit suspension component for a vehicle comprising:
at least two ball joints wherein each said ball joint is configured with a ball portion and a ball stud portion; and
a case configured to rotatably enclose at least two said ball joints wherein said ball stud portions of said ball joints project 180 degrees in opposite directions, through said case.

9. The ball joint unit suspension component of claim 8, wherein a line connecting centers of balls of the first and second ball studs is at about 45 degrees with respect to a horizontal plane.

10. The ball joint unit suspension component of claim 8, wherein said ball stud is configured to couple with a control arm.

11. The ball joint unit suspension component of claim 8, wherein said case is configured to couple with a wheel carrier.
